(19) United States
(12) Patent Application Publication
(10) Pub. No.: US 2017/0370661 A1
(43) Pub. Date: Dec. 28, 2017

(54) HEAT TRANSFER SYSTEM WITH COATED FLUID CONDUIT

(71) Applicant: CARRIER CORPORATION, Farmington, CT (US)

(72) Inventors: Randolph Carlton McGee, Hamden, CT (US); Parmesh Verma, South Windsor, CT (US); Wayde R. Schmidt, Pomfret Center, CT (US); James T. Beals, West Hartford, CT (US)

(21) Appl. No.: 15/534,936

(22) PCT Filed: Dec. 11, 2015
(86) PCT No.: PCT/US2015/065267

§ 371 Date: Jun. 9, 2017

Related U.S. Application Data
(60) Provisional application No. 62/091,272, filed on Dec. 12, 2014.

(51) Int. Cl. F28F 19/04; F25B 1/00; F16L 58/18; F16L 58/10; F28F 21/08; C09D 175/04

(52) U.S. Cl. CPC F28F 19/04; F28F 2265/16; F28F 21/085; F28F 21/084; C09D 175/04; F16L 58/181; F16L 58/1054; F25B 1/00

(57) ABSTRACT

A heat transfer system having a heat transfer fluid circulation loop of a first fluid is disclosed. A conduit is disposed in the fluid circulation loop with an inner surface in contact with the first fluid at a first pressure. An outer surface of the first conduit is in contact with a second fluid at a second pressure that is 69 kPa to 13771 kPa (10 psi to 2000 psi) higher than the first pressure. The conduit also includes a polyurea coating on its outer surface.

### BACKGROUND OF THE INVENTION

The subject matter disclosed herein generally relates to heat transfer systems, and more particularly to systems with coated heat transfer fluid conduits.

Heat transfer systems are widely used in various applications, including but not limited to environmental heating and cooling systems, heating and cooling in various industrial and chemical processes, heat recovery systems, and the like, to name a few. Many heat transfer systems transfer heat by transporting a heat transfer fluid through one or more conduits. Often times, the fluid must be pressurized, such as in a vapor compression heat transfer system where the heat transfer fluid is compressed as part of a heat cycle. Heat transfer fluid pressure may also be required for other reasons such as to provide desired flow rates under various system conditions, such as to overcome back pressure from small flow paths through components like heat exchangers.

Heat transfer systems are often deployed in environments where they can be susceptible to corrosion. In applications in or close to marine environments, particularly, sea water or wind-blown seawater mist create an aggressive chloride environment that is detrimental for heat transfer systems. This chloride environment rapidly causes localized and general corrosion of braze joints, fins, and refrigerant tubes. The corrosion modes include galvanic, crevice, and pitting corrosion. Corrosion can eventually lead to a loss of refrigerant due to tube perforation, resulting in failure of the cooling system. With the advent of new refrigerants having low global warming potential (GWP), but also sometimes greater flammability and/or toxicity than previous higher GWP refrigerants, leaks of refrigerant has become an increasingly serious problem.

Surface coatings have been used to provide protection against corrosion by imposing a physical barrier between moisture and corrosive materials in the environment and components of the heat transfer system. Coating types include electroplating, dip coating, spray coating and powder coating. However, conventional polymer surface coatings can suffer from a number of problems such as inadequate or uneven thickness, pinholes and other gaps in coating coverage, and the necessity of extensive surface preparation of the substrate prior to application of the coating. Additionally, conventional surface coatings typically do nothing to contain a leak in the event that the substrate is perforated.

### BRIEF DESCRIPTION OF THE INVENTION

According to an aspect of the invention, a heat transfer system comprises a circulation loop of a first fluid. A conduit is disposed in the circulation loop having an inner surface in contact with the first fluid at a first pressure. An outer surface of the first conduit is in contact with a second fluid at a second pressure that is 69 kPa to 13771 kPa (10 psi to 2000 psi than the first pressure. The heat transfer system also includes a polyurea coating on the conduit's outer surface.

According to some aspects of the invention, the polyurea coating has a thickness of 100-2600 μm.

According to some aspects of the invention, the polyurea coating has a thickness of 250-1000 μm.

According to some aspects of the invention, the polyurea coating has a thickness of 760-2540 μm (30-100 mils).

According to some aspects of the invention, the polyurea coating has a tensile strength of at least 1.52 MPa (2200 psi) as determined according to ASTM D638-10.

According to some aspects of the invention, the polyurea coating has a tensile strength of 1.52-1.72 MPa (2200-2500 psi) as determined according to ASTM D638-10.

According to some aspects of the invention, the polyurea coating has an elongation of 300-350%, as determined according to ASTM D638-10.

According to some aspects of the invention, the polyurea coating has an adhesion to the conduit's outer surface of 800 to 1000 psi, as determined according to ASTM D4541.

According to some aspects of the invention, the outer surface includes a joint with a second conduit.

According to some aspects of the invention, the first conduit comprises a first metal alloy, and the second conduit comprises a second metal alloy different from the first metal alloy.

According to some aspects of the invention, the first metal alloy is a copper alloy, and the second metal alloy is an aluminum alloy.

According to some aspects of the invention, the second metal aluminum alloy is a part of a heat exchanger comprising aluminum alloy tubes.

According to some aspects of the invention, only joints between conduits are covered by said coating.

According to some aspects of the invention, all conduits in the heat transfer system are covered by said coating.

According to some aspects of the invention, the first fluid has a flammability rating of less than or equal to 3 according to ASHRAE standard 34-2013.

According to some aspects of the invention, the first fluid has a toxicity rating of less than or equal to B according to ASHRAE standard 34-2013.

According to some aspects of the invention, the heat transfer system is a vapor compression heat transfer system comprising a compressor, a heat rejection heat exchanger, an expansion device, a heat absorption heat exchanger, connected together by a plurality of conduits to form the circulation loop, and the first fluid is a heat transfer fluid disposed in the circulation loop. In some of these aspects, at least one of said plurality of conduits can comprise a copper alloy connected at a connection joint to an aluminum alloy tube on the heat rejection heat exchanger or the heat absorption heat exchanger, and the coating is disposed on and adjacent to the connection joint.

According to some aspects of the invention, the second fluid is air at atmospheric pressure or water.

According to some aspects of the invention, the polyurea coating is applied during manufacture of the heat transfer system.

According to some aspects of the invention, the polyurea coating is field-applied after manufacture of the heat transfer system.

According to another aspect of the invention, a method of operating any of the above heat transfer systems comprises flowing a first fluid through the conduit at a first pressure, with a second fluid at a second pressure along the outer surface of the conduit, wherein the first pressure is higher than the second pressure by 35 psi to 585 psi

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawing in which:

FIG. 1 depicts a schematic diagram of an exemplary heat transfer system;

FIG. 2 depicts a schematic diagram of a cross-sectional view of a surface of a coated heat transfer system conduit as described herein;

FIG. 3 depicts a schematic diagram of a cross-sectional view of a coated heat transfer system conduit joint as described herein; and

FIG. 4 depicts a schematic diagram of a cross-sectional view of a coated heat transfer system conduit joint as described herein.

### DETAILED DESCRIPTION OF THE INVENTION

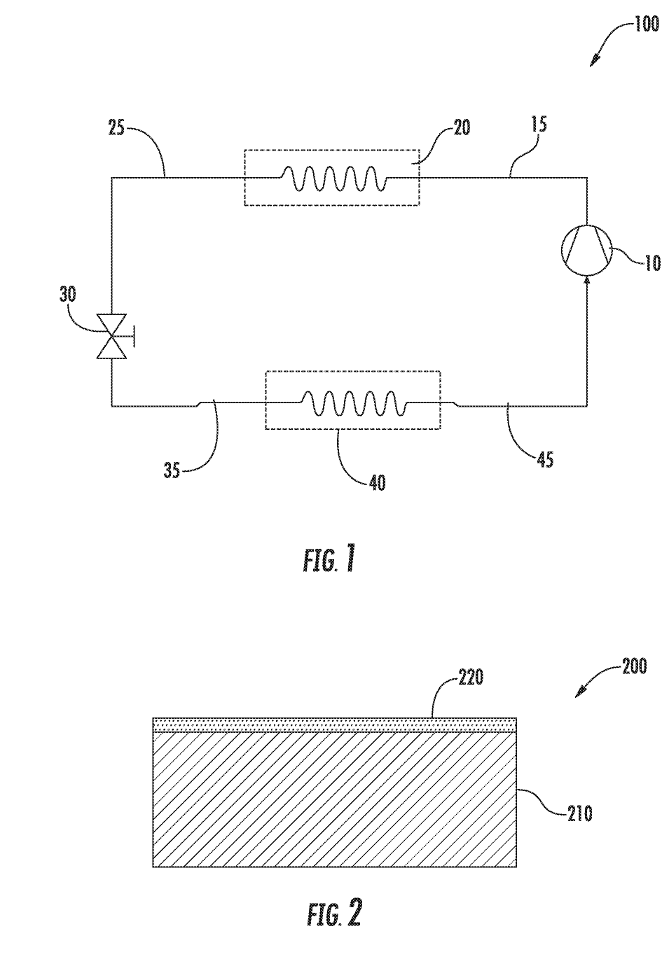

Referring now to the Figures, an exemplary heat transfer system with a heat transfer fluid circulation loop is shown in block diagram form in FIG. 1. As shown in FIG. 1, a compressor 10 pressurizes heat transfer fluid in its gaseous state, which both heats the fluid and provides pressure to circulate it throughout the system. The hot pressurized gaseous heat transfer fluid exiting from the compressor 10 flows through conduit 15 to heat rejection heat exchanger 20, which functions as a heat exchanger to transfer heat from the heat transfer fluid to the surrounding environment, resulting in condensation of the hot gaseous heat transfer fluid to a pressurized moderate temperature liquid. The liquid heat transfer fluid exiting from the heat rejection heat exchanger 20 (e.g., a condenser) flows through conduit 25 to expansion valve 30, where the pressure is reduced. The reduced pressure liquid heat transfer fluid exiting the expansion valve 30 flows through conduit 35 to heat absorption heat exchanger 40 (e.g., an evaporator), which functions as a heat exchanger to absorb heat from the surrounding environment and boil the heat transfer fluid. Gaseous heat transfer fluid exiting the heat rejection heat exchanger 40 flows through conduit 45 to the compressor 10, thus completing the heat transfer fluid loop. The heat transfer system has the effect of transferring heat from the environment surrounding the evaporator 40 to the environment surrounding the heat rejection heat exchanger 20. The thermodynamic properties of the heat transfer fluid allow it to reach a high enough temperature when compressed so that it is greater than the environment surrounding the condenser 20, allowing heat to be transferred to the surrounding environment. The thermodynamic properties of the heat transfer fluid must also have a boiling point at its post-expansion pressure that allows the environment surrounding the heat rejection heat exchanger 40 to provide heat at a temperature to vaporize the liquid heat transfer fluid.

The heat transfer system shown in FIG. 1 can be used as an air conditioning system, in which the exterior of heat rejection heat exchanger 20 is contacted with air in the surrounding outside environment and the heat absorption heat exchanger 40 is contacted with air in an interior environment to be conditioned. Additionally, as is known in the art, the system can also be operated in heat pump mode using a standard multiport switching valve to reverse heat transfer fluid flow direction and the function of the condensers and evaporators, i.e. the condenser in a cooling mode being evaporator in a heat pump mode and the evaporator in a cooling mode being the condenser in a heat pump mode. Additionally, while the heat transfer system shown in FIG. 1 has evaporation and condensation stages for highly efficient heat transfer, other types of heat transfer fluid loops are contemplated as well, such as fluid loops that do not involve a phase change, for example, multi-loop systems such as commercial refrigeration or air conditioning systems where a non-phase change loop thermally connects one of the heat exchangers in an evaporation/condensation loop like FIG. 1 to a surrounding outside environment or to an interior environment to be conditioned. The coating described herein adds a backup for preventing leaks through the conduit walls. This can be useful with all types of refrigerants to prevent the loss of valuable refrigerants, but can be especially useful for preventing leaks of flammable and/or toxic refrigerants. Accordingly, in some embodiments, the heat transfer system utilizes a heat transfer fluid having a flammability rating of less than or equal to 3 (e.g., 2L, 2 or 3) according to ASHRAE standard 34-2013. In some embodiments, the heat transfer system utilizes a heat transfer fluid having a toxicity rating of less than or equal to B (e.g., A or B), and in some embodiments equal to B, according to ASHRAE standard 34-2013, for which it is particularly desirable to avoid leaks. Regardless of the specific configuration of the heat transfer fluid circulation loop, a heat transfer system may be disposed in a potentially corrosive environment such as a marine or ocean shore environment.

A cross-section of a coated conduit surface is schematically depicted in FIG. 2, which shows a cross sectional view of a portion of a conduit 210 having a top surface coat of polyurea coating layer 220. In some exemplary embodiments, the thickness of the polyurea coating ranges from 100-2600 μm. In some exemplary embodiments, the thickness of the polyurea coating ranges from 250-1000 μm. In some exemplary embodiments, the thickness of the polyurea coating ranges from 760-2540 μm (30-100 mils).

Refrigerant conduit joints can be particularly susceptible to refrigerant loss. Many refrigerant system control schemes utilize on/off cycles where portions of the system can be subject to cycles in pressure that result in cycled application of stress to flaws in a braze or weld joint, which can over time result in an opening or perforation through which refrigerant can escape. Accordingly, in some embodiments, the polyurea coating is disposed over a joint between two or more conduits. Additionally, conduit joints must sometimes be formed between different types of metal. For example, aluminum alloys are lightweight, have a relatively high specific strength and high heat conductivity, and have beneficial physical properties for fabrication and operation of heat exchanger fins and tubes. However, copper tubing provides physical properties that are beneficial for the fabrication and operation of heat transfer system tubes that connect the system components such as compressors, heat rejection heat exchangers, expansion devices, and heat absorption heat exchangers. Refrigerant conduit joint connections, such as a connection of an all-aluminum tube heat exchanger inlet or outlet to a copper refrigerant conduit, can lead to galvanic corrosion of the sacrificial metal (aluminum as the anode in the case of a copper-aluminum galvanic circuit). Accordingly, although the polyurea coating can be applied on any tube or conduit, or indeed on all of the tubes and conduits in the heat transfer system, in some embodiments the polyurea coating is disposed over a joint between two or more conduits including but not limited to copper-copper joints or aluminum-aluminum joints, or over a joint between two or more conduits of different metals including but not limited to copper-aluminum joints.

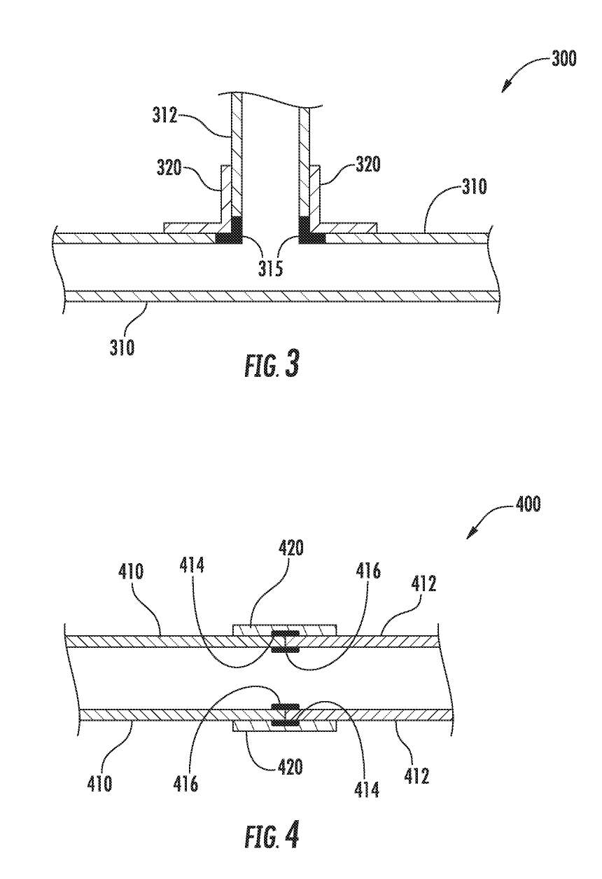

FIG. 3 depicts a 90° conduit joint 300 between conduit 310 and conduit 312. The joint 300 has a joint seam area 315 where the joined conduits 310, 312 have either been welded together or brazed together with a brazing composition. The joint seam area 315 and adjacent areas of the conduits 310, 312 are covered with a polyurea coating 320. A joint seam area 315. FIG. 4 depicts a straight-line joint 400 between conduit 410 and conduit 412. The joined conduits 410, 412 are shown in this figure with an outer joint seam 414 and an inner joint seam 416 where the joined conduits 310, 312 have either been welded together or brazed together with a brazing composition. The outer joint seam 414 and the adjacent areas of the conduits 410, 412 are covered with a polyurea coating 420.

The refrigerant tubes can be made of any metal alloy with the requisite physical, thermal, and chemical properties for the particular application at hand. Exemplary aluminum alloys include aluminum alloys selected from 1000 series, 3000 series, 5000 series, or 6000 series aluminum alloys. Specific aluminum alloys include, but are not limited to AA3003, AA7075, and AA2219. Exemplary copper alloys include alloys selected from the UNSC12200 series. Specific copper alloys include, but are not limited to 90/10 Cu—Ni, 80/20 Cu—Ni, and 70/30 Cu—Ni.

As mentioned above, conduits can be connected by known techniques such as welding or brazing. Brazing compositions for aluminum components are well-known in the art as described, for example, in U.S. Pat. Nos. 4,929,511, 5,820,698, 6,113,667, and 6,610,247, and US published patent application 2012/0170669, the disclosures of each of which are incorporated herein by reference in their entirety. Brazing compositions for aluminum can include various metals and metalloids, including but not limited to silicon, aluminum, zinc, magnesium, calcium, lanthanide metals, and the like. In some embodiments, the brazing composition includes metals more electrochemically anodic than aluminum (e.g., zinc), in order to provide sacrificial galvanic corrosion in the braze joint(s) instead of the refrigerant tube(s).

A flux material can be used to facilitate the brazing process. Flux materials for brazing of aluminum components can include high melting point (e.g., from about 564° C. to about 577° C.), such as LiF and/or KAlF₄. Other compositions can be utilized, including cesium, zinc, and silicon. The flux material can be applied to the aluminum alloy surface before brazing, or it can be included in the brazing composition.

As described above, the pressure of the fluid inside the first conduit (i.e., coated heat transfer fluid conduit) is about 69 kPa to 13,771 kPa (10 psi to 2000 psi) greater than the pressure of fluid on the outside of the conduit. In some embodiments, the pressure of the fluid inside the first conduit is about 241 kPa to 4033 kPa (35 psi to 585) psi greater than the pressure of fluid on the outside of the conduit. In some heat transfer systems such as the refrigeration system depicted in FIG. 1, the fluid on the outside of the conduit is air at atmospheric pressure. The fluid on the inside of the conduit is typically a refrigerant such as a hydrocarbon or a fluoro-substituted hydrocarbon. Typical internal refrigerant pressures can range from 10 psi to 2000 psi, more specifically from 35 psi to 500 psi, although as mentioned above, the invention encompasses pressure differentials up to 13,771 kPa (2000 psi).

As described above, the pressurized conduit has a polyurea coating on its outer surface. In some embodiments, the polyurea coating has a tensile strength of at least 1.52 MPa (2200 psi). In some embodiments, the polyurea coating has a tensile strength 1.52-1.72 MPa (2200-2500 psi).

The polyurea coating is typically applied by spray application of a two-component coating composition comprising a polyisocyanate component, a polyamine component, and optionally other reactive and non-reactive components for the coating composition. Exemplary polyisocyanate components include methylene diisocyanate, ethylene diisocyanate, 1,3-propanediisocyanate, 1,4-butanediisocyanate, 1,5-pentanediisocyanate, 1,6-hexanediisocyanate, hexamethylene diisocyanate (HDI), and isophorone diisocyanate (IPDI), and aromatic diisocyanates, such as methylene diphenyl diisocyanate (MDI), toluene diisocyanate (TDI), and naphthalene diisocyanate. Dimerized (biuret) or trimerized (isocyanurate) polyisocyanate structures can also be used.

Isocyanate groups in the polyisocyanate component will react with amine groups on the polyamine component to form urea linkages in a polyurea. Polyamine components for the coating composition include aliphatic diamines, aromatic diamines, amine terminated polyether polyols (i.e., polyether polyamines), and combinations thereof. Exemplary aromatic diamines include diethyltoluenediamine (sold commercially as, e.g., UNILINK 4200), 1-methyl-3,5-diethyl-2,4-diaminobenzene, 1-methyl-3,5-diethyl-2,6-diaminobenzene (both of these materials are also called diethyltoluene diamine or DETDA and are commercially available as ETHACURE 100), 1,3,5-triethyl-2,6-diaminobenzene, 3,5,3′,5′-tetraethyl-4,4′-diaminodiphenylmethane, N,N′-dialkylamino-diphenylmethane, and the like. Aliphatic diamines include the chain extenders as described in U.S. Pat. Nos. 4,246,363 and 4,269,945, and/or 1,3-diaminopropane, 1,4-diaminobutane, 1,5-diaminopentane, 1,6-diaminohexane. Other diamines include di(methylthio)-toluene diamine or N,N′-bis(t-butyl) ethylenediamine. Cycloaliphatic diamines that can be used include cis-1,4-diamino cyclohexane, isophorone-diamine, 4,4′-methylene di-cyclohexylamine; methanediamine, and 1,4-diamino-methyl cyclohexane.

Other reactive components can also be included in the coating composition, such as polyols (which react with the polyisocyanate to form urethane linkages) and reactive diluents (i.e., monofunctional active hydrogen compounds such as alcohols and amines). Exemplary polyols include polyether polyols, polyester diols, triols, tetrols, and higher functionality polyols. Those polyether polyols can be based on low molecular weight polyol initiators (e.g., ethylene glycol, propylene glycol, trimethylol propane) that are chain-extended by reaction with alkylene oxides such as ethylene oxide, propylene oxide, butylene oxide, or mixtures thereof. Other high molecular weight polyols which may be useful in this invention are polyesters of hydroxyl terminated rubbers, e.g., hydroxyl terminated polybutadiene. Hydroxyl terminated quasi-prepolymers of polyols and isocyanates can also be used. Reactive diluents include compounds having blocked active hydrogen groups that generate active hydrogen groups during cure, such as aldimines, ketimines, or oxazolidines.

Other conventional formulation ingredients can be included in the coating composition, including, for example, foam stabilizers, also known as silicone oils or emulsifiers, UV stabilizers, non-reactive solvents, etc. Pigments, for example, titanium dioxide or carbon black, may be incorporated in the composition to impart color properties. Reinforcing materials and fillers, can also be included and are known to those skilled in the art. For example, chopped or milled glass fibers, chopped or milled carbon fibers, rubber or rubberized particles, wollostonite, nanotubes, calcium silicate, and/or other mineral fibers can also be used.

The invention is further described by the following Example.

### EXAMPLE

Copper heat transfer system conduits having a wall thickness of 1 mm (0.04 in) were intentionally defected with an opening of 1778 μm, and then coated with a polyurea coating of Rhino-Extreme™ 21-55 polyurea composition at a thickness of 760 μm (30 mils) and cured in accordance with the manufacturer's recommendations. Pressure burst tests were conducted at varying increasing pressures until the coated conduit failed by exhibiting a leak through the opening. The conduits were able to withstand burst pressures up to 4.14 MPa (600 psi).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A heat transfer system comprising a circulation loop of a first fluid, comprising a conduit disposed in said circulation loop, the conduit having an inner surface in contact with the first fluid at a first pressure and an outer surface in contact with a second fluid at a second pressure, wherein the first pressure is higher than the second pressure by 69 kPa to 13771 kPa (10 psi to 2000 psi), and wherein the conduit includes a coating on the second surface comprising a polyurea.

2. The heat transfer system of claim 1, wherein the polyurea coating has a thickness of 100-2600 μm.

3. The heat transfer system of claim 1, wherein the polyurea coating has a thickness of 250-1000 μm.

4. The heat transfer system of claim 1, wherein the polyurea coating has a thickness of 760-2540 μm.

5. The heat transfer system of claim 1, wherein the polyurea coating has a tensile strength of at least 1.52 MPa (2200 psi), as determined according to ASTM D638-10.

6. The heat transfer system of claim 5, wherein the polyurea coating has a tensile strength of 1.52-1.72 MPa (2200-2500 psi), as determined according to ASTMD638-10.

7. The heat transfer system of claim 1, wherein the polyurea coating has an elongation of 300-350%, as determined according to ASTM D638-10.

8. The heat transfer system of claim 1, wherein the polyurea coating has an adhesion to the conduit's outer surface of 800 to 1000 psi, as determined according to ASTM D4541.

9. The heat transfer system of claim 1, wherein the outer surface includes a joint with a second conduit.

10. The heat transfer system of claim 9, wherein the first conduit comprises a first metal alloy, and the second conduit comprises a second metal alloy different from the first metal alloy.

11. The heat transfer system of claim 10, wherein the first metal alloy is a copper alloy and the second metal alloy is an aluminum alloy.

12. The heat transfer system of claim 11, wherein the second conduit is part of a heat exchanger comprising aluminum alloy tubes.

13. The heat transfer system of claim 9, wherein only joints between conduits are covered by said coating.

14. The heat transfer system of claim 1, wherein all conduits are covered by said coating.

15. The heat transfer system of claim 1, wherein the first fluid has an ASHRAE flammability rating of less than or equal to 3 according to ASHRAE standard 34-2013.

16. The heat transfer system of claim 1, wherein the first fluid has a ASHRAE toxicity rating of less than or equal to B according to ASHRAE standard 34-2013.

17. The heat transfer system of claim 1 that is a vapor compression heat transfer system comprising a compressor, a heat rejection heat exchanger, an expansion device, a heat absorption heat exchanger, connected together by a plurality of conduits to form said circulation loop, and said first fluid is a heat transfer fluid disposed in said circulation loop.

18. The heat transfer system of claim 17, at least one of said plurality of conduits comprises a copper alloy connected at a connection joint to an aluminum alloy tube on the heat rejection heat exchanger or the heat absorption heat exchanger, and said coating is disposed on and adjacent to the connection joint.

19. The heat transfer system of claim 1, wherein the second fluid is air at atmospheric pressure.

20. (canceled)

21. (canceled)

22. A method of operating the heat transfer system of claim 1, comprising flowing the first fluid through the conduit at a first pressure, with a second fluid at a second pressure along the outer surface of the conduit, wherein the first pressure is higher than the second pressure by 10 psi to 2000 psi.
